(19) United States
(12) Patent Application Publication
(10) Pub. No.: US 2007/0164146 A1
(43) Pub. Date: Jul. 19, 2007

(54) Rotary wing aircraft

(75) Inventor: Thomas G. Stephens, Grand Prairie, TX (US)

Correspondence Address: IP SECTION, GARDERE WYNNE SEWELL LLP;3000 THANKSGIVING TOWER, SUITE 3000, 1601 ELM STREET, DALLAS, TX, 75201, US

(73) Assignee: TGS INNOVATIONS, LP, DALLAS, TX (US)

(21) Appl. No.: 11/411,540

(22) Filed: Apr. 26, 2006

Related U.S. Application Data
(63) Continuation-in-part of application No. 11/121,648, filed on May 4, 2005.

(51) Int. Cl. B64C 27/26

(52) U.S. Cl. 244/10

(57) ABSTRACT

A rotary wing aircraft is provided with longitudinally oriented counter-rotating rotors with circumferentially spaced variable pitch rotor blades connected to rotatable support rings mounted on the aircraft fuselage. Rotor downwash may be guided laterally and longitudinally by respective sets of moveable guide vanes. Propulsion may be obtained by an engine providing thrust and power take-off for driving the rotors. An auxiliary or second engine may be drivingly connected to the rotors. One embodiment includes rotors with lift or blade pitch angle control mechanism for changing the resultant lift forces for providing aircraft lateral movement and movement about a yaw axis. A wind driven power turbine includes a similar pitch angle control mechanism.

### CROSS REFERENCE TO RELATED APPLICATION

This application is a continuation-in-part of copending application Ser. No. 11/121,648, filed May 4, 2005.

### BACKGROUND OF THE INVENTION

The continuing rapid development of aviation technologies with respect to aircraft structures, propulsion systems and navigation systems augers well for expanded use of aircraft by professional aviators and the general public. However, one drawback to the continued proliferation of general aviation aircraft, for example, is with respect to the space needs for fix-winged aircraft as well as conventional rotary wing aircraft. Fixed wing aircraft, of course, require substantial space for take-off and landing operations and conventional rotary wing aircraft require substantial space for storage. Accordingly, there has been a continuing need to develop aircraft which have short take-off and landing (STOL) or substantially vertical take-off and landing (VTOL) capabilities, as well as minimal storage space requirements.

Certain efforts have been made to develop rotary wing aircraft with rotors which are characterized by elongated blades arranged in a generally circular pattern and secured to ring-like support structures at opposite ends of the blades. However, prior art efforts have been focused on rotary wing aircraft with rotors which are arranged for rotation about axes normal to the longitudinal axis of the aircraft and its preferred direction of flight. Certain efforts have been put forth to develop rotary wing aircraft of the general type discussed above which have rotors arranged longitudinally. However, prior art efforts have been indicated to provide aircraft designs which are complicated and lack stability in the event of failure of one or more rotor sets. Moreover, space requirements for prior art rotary wing aircraft have been, generally, similar to the needs of conventional rotary wing or helicopter aircraft.

Accordingly, there has been a continuing need and desire to provide aircraft which are compact, stable in flight operations, capable of STOL or VTOL operations and which meet the conventional needs of general aviation as well as commercial aircraft. It is to these ends that the present invention has been developed. Certain needs in the development of wind driven power turbines and the like are also met by the present invention.

### SUMMARY OF THE INVENTION

The present invention provides an improved rotary wing powered aircraft. The present invention also provides an improved rotary wing aircraft with plural rotors which are arranged for rotation about an axis, preferably, coincident with or parallel to the longitudinal axis of the aircraft and wherein the rotors are counter-rotating so as to substantially eliminate undesirable torque or force reaction characteristics.

In accordance with one aspect of the present invention, a rotary wing aircraft is provided of a type which includes, preferably, plural rotors arranged for rotation about an axis substantially coincident with or parallel to the longitudinal central axis of the aircraft. The rotors are of a type characterized by elongated variable pitch blades which are pivotally supported on spaced-apart, generally cylindrical ring members or radially extending support members mounted for rotation with respect to an aircraft frame or fuselage. The rotors are arranged to provide for change of pitch of the rotor blades as they rotate through one revolution so that rotor wake or downwash is directed, generally, vertically downwardly or in a selected direction to provide suitable lifting forces. Moreover, the rotors are preferably interconnected and are operable to rotate in opposite directions so as to minimize adverse torque reactions on the aircraft.

In accordance with another aspect of the present invention a rotary wing aircraft is provided which includes one or more multi-bladed rotors arranged to propel air through a large duct or opening in the aircraft fuselage in a generally downward direction and wherein adjustable guide vanes are disposed in the opening to bias the flow of air in different directions for controlling movement of the aircraft. In at least one embodiment of the invention the rotors may not require to be disposed in or adjacent to any ducting.

Still further, the invention includes an arrangement of rotors in a rotary wing aircraft wherein a propulsion engine may share power required to propel the aircraft in a forward direction with power required to rotate the aircraft rotors. Still further, the rotary wing aircraft of the invention may utilize plural engines arranged to provide power input to the rotors through a unique power train. One of the engines may be utilized as an auxiliary or back-up engine in the event of a failure of or power reduction from a main engine.

In accordance with yet a further aspect of the invention, a rotary wing aircraft is provided with an arrangement of fore and aft disposed rotors which are operable to rotate about axes which generally are parallel to a longitudinal central axis of the aircraft. The aircraft may be equipped with lift and stability control surfaces which may also include control surfaces, such as an elevator and/or a rudder. The aircraft may include fixed wings of relatively short span, but providing for increased lift and stability about the aircraft roll axis.

The present invention also provides an improved wind driven power turbine, particularly of a type used for generating electricity. In particular, a wind driven power turbine is provided which is characterized by a turbine or rotor which, preferably, is adapted to rotate about a substantially vertical axis and includes a mechanism for orienting the turbine or rotor blades for maximum efficiency of operation with respect to the direction of the wind acting on the turbine or rotor.

Those skilled in the art will further appreciate the above-mentioned advantages and superior features of the rotary wing apparatus of the invention together with other important aspects thereof upon reading the detailed description which follows in conjunction with the drawing.

### BRIEF DESCRIPTION OF THE DRAWINGS

FIG. 1 is a front perspective view of one preferred embodiment of a rotary wing aircraft in accordance with the present invention;

FIG. 2 is rear perspective view of the aircraft shown in FIG. 1;

FIG. 3 is a top plan view of the aircraft shown in FIGS. 1 and 2;

FIG. 4 is a section view taken generally along the line 4-4 of FIG. 3;

FIG. 5 is a detail section view taken generally along the line 5-5 of FIG. 3 with portions of the fuselage omitted;

FIG. 6 is a cut-away perspective view of the aircraft shown in FIGS. 1-5 and illustrating certain features of the aircraft;

FIG. 7 is a detail view illustrating a portion of an auxiliary drive train;

FIG. 8 is a detail perspective view illustrating a driving connection between fore and aft mounted rotors for the aircraft shown in FIGS. 1-6;

FIG. 9 is a detail section view taken generally along the line 9-9 of FIG. 3;

FIG. 10 is a top plan view of another preferred embodiment of a rotary wing aircraft in accordance with the invention;

FIG. 11 is a side elevation of the aircraft shown in FIG. 10;

FIG. 12 is a rear elevation of the aircraft shown in FIGS. 10 and 11;

FIG. 13 is a perspective view of still another preferred embodiment of a rotary wing aircraft in accordance with the invention;

FIG. 14 is a section view taken generally from the line 14-14 of FIG. 17C;

FIG. 14A is a detail section view taken from line 14-14 showing a typical rotor blade connection to its support and pitch change linkage;

FIG. 15 is a view similar to FIG. 14 on a larger scale;

FIG. 16 is a detail cutaway perspective view of the rotor drive mechanism between the fore and aft rotors;

FIGS. 17A, 17B and 17C are detail section views of rotor support and drive mechanism and are taken along line 17-17 of FIG. 13;

FIG. 18 is a front elevation view of the aircraft embodiment shown in FIGS. 13 through 17C;

FIG. 19 is another front elevation view of the aircraft embodiment shown in FIGS. 13 through 18;

FIG. 20 is a perspective view of a wind driven power turbine in accordance with the present invention;

FIG. 21 is a detail cutaway perspective view of the upper end of the turbine rotor illustrating the drive connection to a power takeoff shaft; and

FIG. 22 is a cutaway perspective view of the turbine or rotor blade pitch change control mechanism for the power turbine of the present invention.

### DETAILED DESCRIPTION OF THE PREFERRED EMBODIMENTS

In the description which following like elements are marked throughout the specification and drawing with the same reference numerals, respectively. The drawing figures are not necessarily to scale and certain elements may be shown exaggerated in scale or in somewhat generalized or schematic form in the interest of clarity and conciseness.

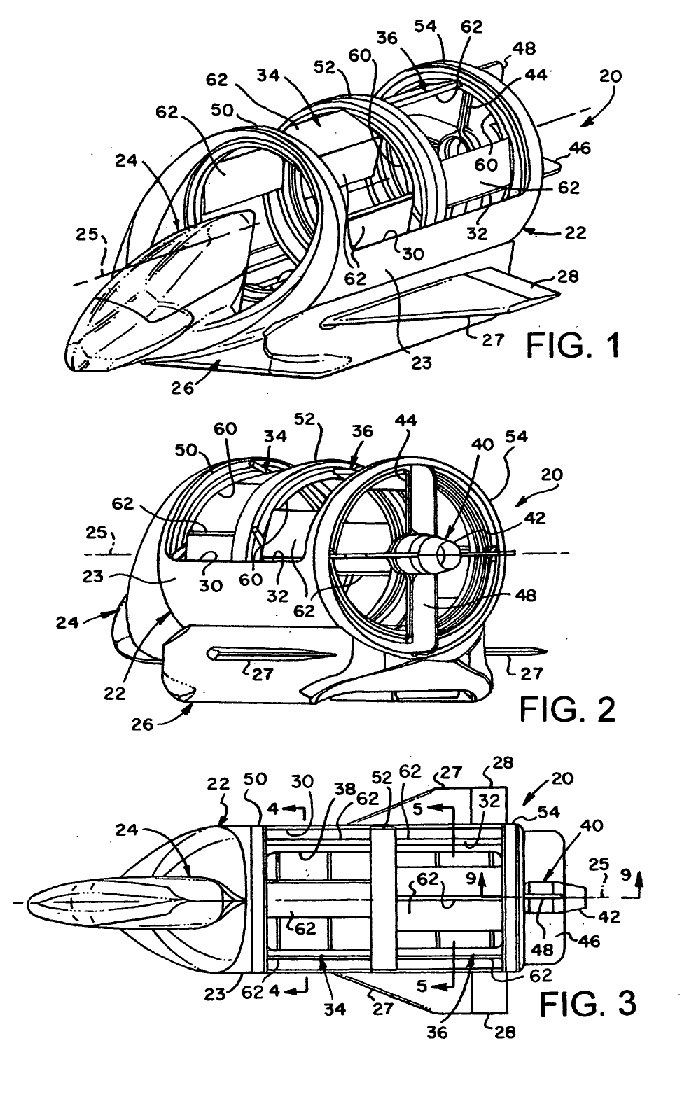

Referring now to FIGS. 1 through 3, there is illustrated a rotary wing aircraft in accordance with the invention and generally designated by the numeral 20. The aircraft 20 includes a generally cylindrical elongated fuselage or body 22 which includes, at the forward end thereof, a cabin 24 for flight crew and passengers. The fuselage 22 is further characterized by a depending, blended rectangular body part or section 26 supporting opposed low aspect ratio wings 27. Wings 27 may include conventional control surfaces 28 comprising ailerons or flaps, for example. Conventional landing gear, wheel or skid type, not shown, may be mounted on fuselage section 26.

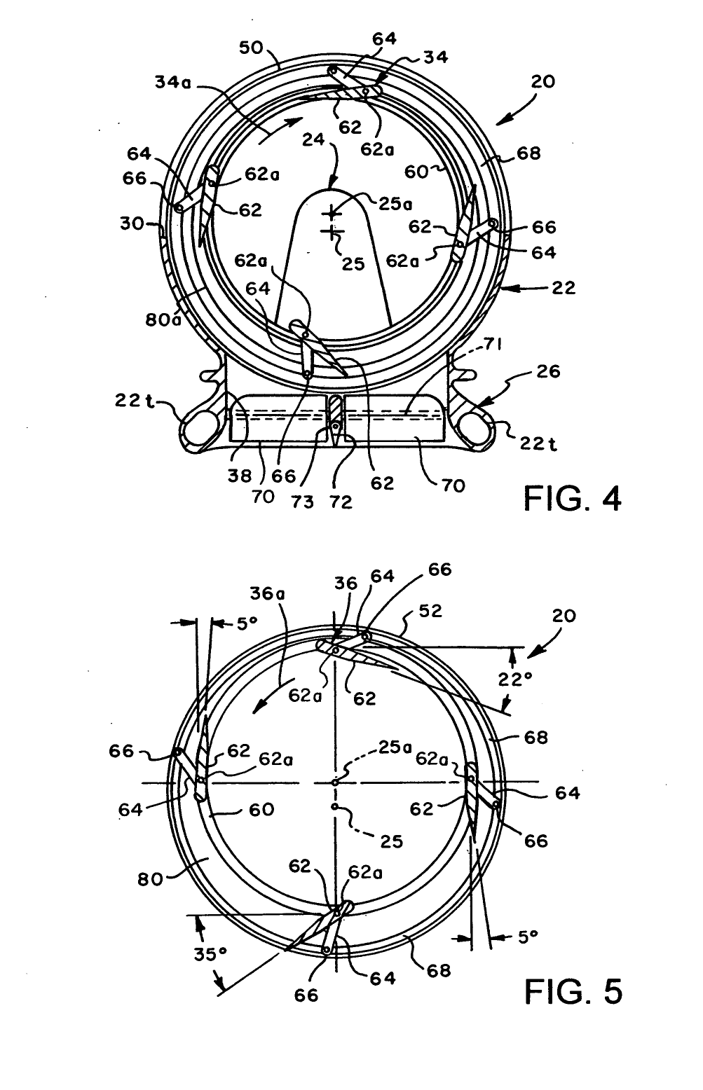

The fuselage 22 is characterized by a substantially tubular elongated section or body part 23 which is open at opposite ends, defines a central longitudinal axis 25 and is cut-away substantially about its upper half to provide substantial longitudinally spaced openings 30 and 32 to permit air inlet to coaxially aligned counter-rotating rotors 34 and 36. The lower, generally rectangular section 26 of fuselage 22 also defines an elongated generally rectangular duct or opening 38, FIG. 3, directly below rotors 34 and 36. Fuel and/or cargo bays 22t, FIG. 4, may be provided in fuselage section 26, for example. The aircraft 20 includes an aft mounted engine 40, FIGS. 2 and 3, which may comprise a gas turbine engine having a jet nozzle 42, but also adapted for at least partial shaft power take-off as will be described further herein. Engine 40 is mounted on suitable support structure 44, FIGS. 1 and 2, generally along central axis 25, which support structure is also operable to support a horizontal stabilizer which may comprise an elevator 46, and a vertical stabilizer which may also comprise a rudder 48. Fuselage 22 also comprises spaced apart, fixed, generally cylindrical rotor support ring members 50, 52 and 54, which delimit, partially, the openings 30 and 32 in fuselage 22.

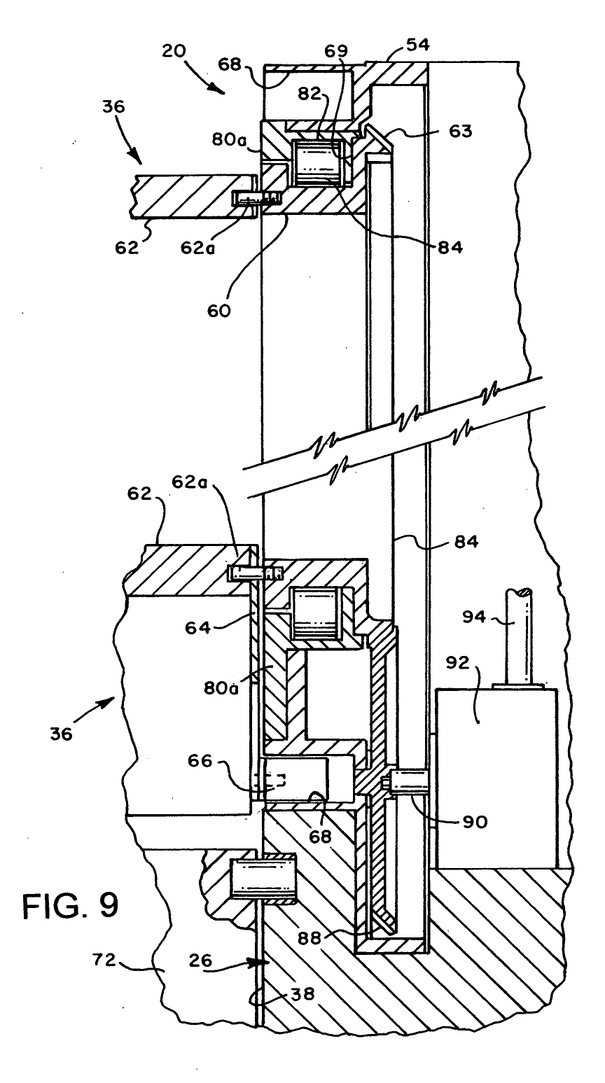

Referring now to FIGS. 4 and 5 also, rotor 34, FIG. 4, is characterized by spaced apart, cylindrical rotor support rings 60, see FIGS. 1 and 4, which have a radially outward facing channel shaped cross section providing a channel 61, see FIG. 8 also. Support rings 60 support therebetween four circumferentially spaced rotor blades 62, FIG. 4, which are mounted for pivotal movement at their respective opposite ends on rings 60 by respective pivot pins 62a. Rotor blades 62 have an airfoil shaped cross-section which may be symmetrical about a central chord line. Rotor blades 62 are also each provided at their opposite ends with support brackets 64, FIG. 4, the distal ends of which are connected to track follower members 66, see FIG. 6 also. Track followers 66 reside in circular channel shaped tracks 68, see FIGS. 8 and 9, which open in a direction parallel to axis 25. FIGS. 8 and 9 show the configuration of opposed channel shaped tracks 68 formed in support ring 52, and a single channel shaped track 68 for support ring 54, respectively. Support ring 50 is configured similar to ring 54 and includes a channel shaped track 68, FIG. 4. Each channel shaped track 68 is circular but the axis of track 68 is eccentric with respect to the axis of rotor support ring 60. Accordingly, as support rings 60 for rotor 34 rotate with respect to support rings 50 and 52 and fuselage 22 the angle of attack or pitch of rotor blades 62 varies such that the blades produce a lifting effect and generate substantial airflow or rotor wash downwardly through duct or opening 38. The direction of rotation of rotor 34 is indicated by arrow 34a in FIG. 4 with respect to rotor axis of rotation 25a which is displaced, as shown, with respect to the central longitudinal axis 25 of the support rings 50, 52, and 54.

As shown in FIG. 5, exemplary values of pitch angle or angle of attack for rotor blades 62 for rotor 36 are illustrated. The angles are measured between rotor blade chord lines and tangents to the circular arc of rotation of the support rings 60 for rotors 34 and 36. Rotor 36 is also characterized by four circumferentially spaced apart rotor blades 62 and support brackets 64 connected to opposite ends thereof, respectively, and including track followers 66 disposed in corresponding channel shaped guide tracks 68 formed on ring shaped supports 52 and 54, see FIGS. 8 and 9 also. The direction of rotation of rotor 36 with respect to axis 25a, when facing forward and in the same direction as facing when viewing FIG. 4, is indicated by arrow 36a. Accordingly, rotors 34 and 36 rotate in opposite directions, thus tending to cancel, substantially, any adverse reaction torque imposed on the aircraft 20 when the rotors are being rotated to effect lifting of the aircraft. Guide tracks 68 are circular, but may be of other geometries in accordance with rotor blade pitch change requirements of the rotors 34 and/or 36.

Referring to FIGS. 4 through 6, and FIG. 6 in particular, rotor downwash through duct or opening 38 may be guided directionally by sets of spaced apart movable guide vanes including guide vanes 70 which are spaced apart and supported for pivotal movement about axes 71, see FIGS. 4 and 6, normal to the axes 25 and 25a. Guide vanes 70 may be pivoted about their respective axes 71 to direct rotor downwash either forward or aft to assist in controlling and propelling aircraft 20. Still further, a longitudinally oriented set of guide vanes 72 is provided, disposed substantially centrally, and extending longitudinally within opening 38 and supported for pivotal movement about a pivot axis 73, see FIGS. 4 and 6 also. Guide vanes 72 may be remotely controlled to orient rotor downwash airflow laterally with respect to axes 25 and 25a to move aircraft 20 laterally also. The operating positions of both sets of guide vanes 70 and 72 may be controlled from a pilot's cockpit portion of cabin 24 to enhance the maneuverability of aircraft 20.

Referring to FIGS. 8 and 9, each of rotor support rings 60 is provided with a circumferential bevel gear part 63 formed on a flange 69 of channel shaped support ring 60, as illustrated. Bevel gears 63 of adjacent rings 60, FIG. 8, are meshed with one or more idler bevel gears 67, one shown in FIG. 8, supported for rotation on support ring 52 to effect reverse or opposite directions of rotation of rotors 34 and 36. Rotor support rings 60 are supported for rotation about axis 25a spaced from and parallel to central axis 25 of stationary support rings 50, 52, and 54 by respective stationary bearing rings 80 and 80a. Bearing rings 80 may be formed integral with support ring 52, FIG. 8. Bearing ring 80a, FIG. 9, may be formed integral with ring 54 or as a separate part, as shown. Bearing rings 80 and 80a are provided with radially inward facing circumferential channels 82, see FIGS. 8 and 9, in which are disposed spaced apart bearing rollers 84 which support rotor support rings 60 for rotation with respect to bearing rings 80, 80a and fuselage 22 by way of the respective stationary support rings 50, 52, and 54. Bearing rings 80a may require to be split longitudinally and/or laterally to facilitate assembly of these rings with respect to rotor support rings 60 and bearing rollers 84. Conversely, support rings 60 may require to be split laterally and/or longitudinally for purposes of assembly and disassembly of the rotors 34 and 36 with respect to their support structure. Bearing rings 80 may be secured to support ring members 50 and 54, respectively, by conventional fastener means, not shown.

Referring to FIG. 9, rotor 36 is driven by a bevel gear 88 meshed with gear 63 of support ring 60. Gear 88 is drivenly connected to an output shaft 90 of a right angle drive gear transmission 92 which has an input shaft 94. Input shaft 94 is preferably drivenly connected to engine 40, see FIG. 6 also. As mentioned hereinbefore, engine 40 is provided with a suitable shaft power takeoff feature, not shown, for delivering at least part of its power output to shaft 94, the remaining power being delivered as jet thrust via nozzle 42. As further shown in FIG. 9, rotor blades 62, two shown, are supported on rotating support ring 60 by pivot pins 62a, as illustrated. Accordingly, rotors 34 and 36 may be driven in opposite directions of rotation about axis 25a by engine 40 via drive shafting 94, gear transmission 92 and bevel gear 88 which is meshed with integral bevel gear 63 on rotor support ring 60. Power transmission between rotors 34 and 36 is provided by one or more bevel gears 67, one shown, which also accomplishes the change in direction of rotation of rotor 34 with respect to rotor 36.

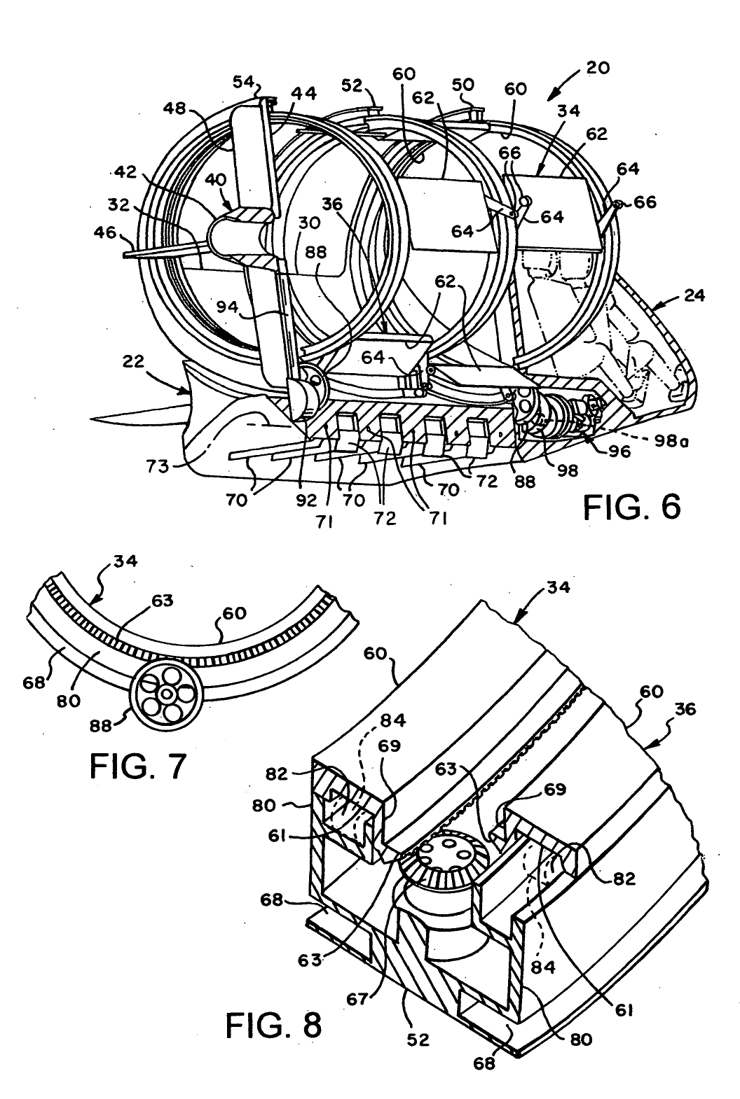

Referring further to FIGS. 6 and 7, a second or auxiliary engine 96, FIG. 6, may be mounted forwardly in fuselage 22, generally where illustrated, and operable to drive a bevel gear 88 via a gear transmission 98. As shown also in FIG. 7, bevel gear 88, which is drivenly connected to engine 96 via transmission 98, is meshed with the bevel gear 63 of the forwardmost rotor support ring 60 for rotor 34. Gear transmission 98 may incorporate an overrunning clutch 98a, FIG. 6, to avoid back driving engine 96 if engine 40 is operating as the primary power source for the rotors 34 and 36 of aircraft 20. Accordingly, engine 96 may be an auxiliary or emergency power source. However, engine 96 may also comprise a part of the primary power source for the rotors 34 and 36 together with engine 40. Engine 96 may be of a type disclosed and claimed in applicant's co-pending patent application Ser. No. 10/939,010, filed Sep. 10, 2004.

The operation of aircraft 20 is believed to be understandable to those of skill in the art from the foregoing description. Rotation of rotors 34 and 36 under driving force exerted by engine 40 and/or engine 96 generates lift and rotor downwash propelled through opening 38, which downwash may be guided both longitudinally and laterally by the respective sets of guide vanes 70 and 72, as described. The eccentric location of axis of rotation 25a for rotors 34 and 36 with respect to the rotor blade pitch or angle of attack guide channels 68 in support rings 50, 52 and 54 will effect the change in attitude of the rotor blades, as illustrated in FIGS. 4 and 5, to provide effective lifting of the aircraft 20 while directing a substantial amount of rotor wash downwardly through opening 38. Aircraft propulsion in longitudinal directions and some pitch control may be obtained at least partially by movement of guide vanes 70 and by stabilizer/elevator 46 and ailerons or flaps 28. Roll control efforts are minimized due to the counter-rotating rotors 34 and 36, but may be carried out by movement of ailerons 28 and/or guide vanes 72, as needed. Control of aircraft 20 about it yaw axis is provided by stabilizer/rudder 48 and/or, possibly, by deflecting selected ones of vanes 72 in opposite directions. Propulsion of aircraft 20 longitudinally may be obtained via engine 40 by jet propulsion, or ducted fan, or unducted propeller. Engine 40 may, for example, be a reciprocating piston type also, for example.

Materials for and methods of construction of aircraft 20 may be conventional and known to those skilled in the art of aircraft fabrication. The mechanical power transmission systems for aircraft 20 may also be fabricated using conventional materials, components and practices known in aircraft power transmission systems.

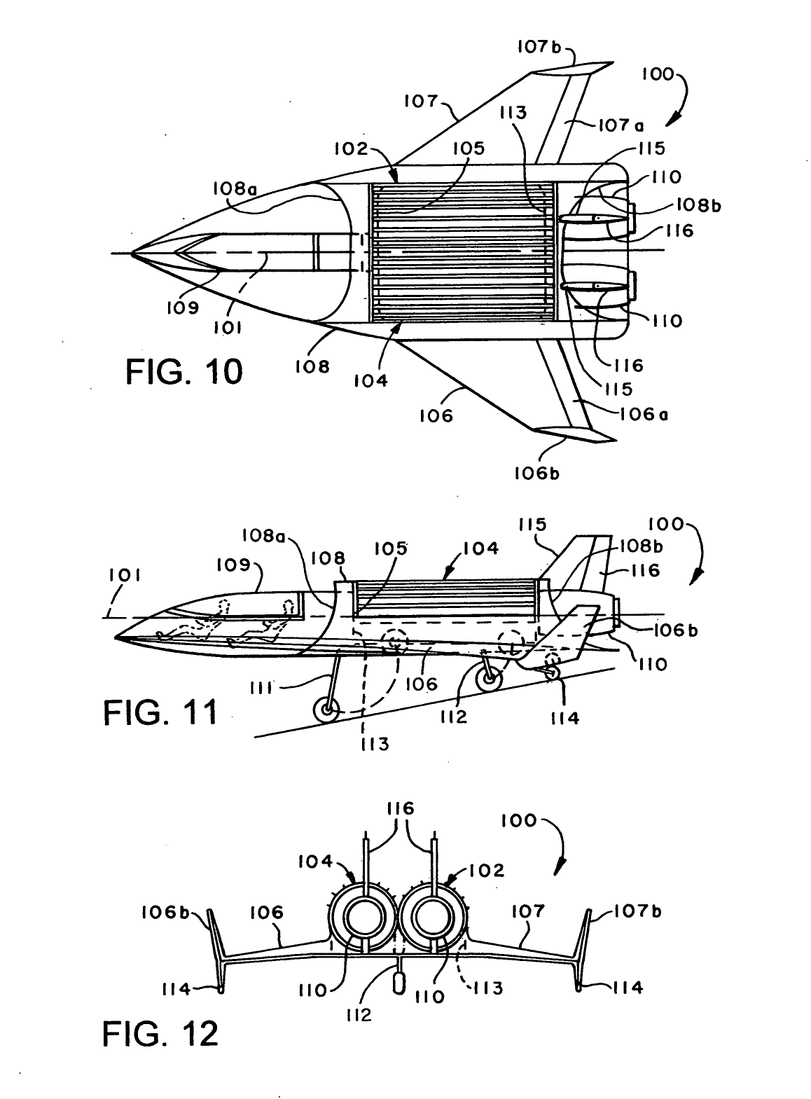

Referring to FIGS. 10 through 12, another preferred embodiment of a rotary wing aircraft in accordance with the invention is illustrated and generally designated by the numeral 100. Aircraft 100 is also characterized by longitudinally oriented rotors 102 and 104 mounted within an opening 105 in a fuselage 108, which fuselage is constructed in some respects similar to the fuselage 22 and includes an enclosed forward disposed cabin/cockpit 109. However, unlike the aircraft 20, rotors 102 and 104 are mounted side by side with respect to a longitudinal central axis 101 of aircraft 100. Aircraft 100 is also provided with opposed, low to moderate aspect ratio wings 106 and 107. Propulsion for rotors 102 and 104 may be provided by side by side aft mounted engines 110 which may be gas turbine types providing at least some jet thrust and which may be adapted for partial shaft power take-off for driving rotors 102 and 104 directly or generally in the same manner as for the rotors for aircraft 20. Rotor downwash is conducted from fuselage 108 via a duct 113, FIGS. 11 and 12, which opens through the bottomside of fuselage 108. Fuselage 108 is preferably provided with openings 108a and 108b at opposite ends, in a manner similar to fuselage 22.

Aircraft 100 is provided with tandem, fuselage mounted, main landing gear members 111 and 112 and wingtip mounted auxiliary landing gear members 114, as illustrated. Landing gear members 111, 112 and 114 may be retractable. Yaw control of aircraft 100 may be provided by spaced apart vertical stabilizers 115 and rudders 116. Roll control requirements are minimized by counter rotating rotors 102 and 104. Roll control may be provided by combination ailerons and flaps 106a, 107a, FIG. 10. Upturned wingtip airfoil members or winglets 106b and 107b may be provided also, as shown. Aircraft 100 may be constructed using, generally, the same techniques and materials as aircraft 20. Aircraft 100 enjoys the same benefits of construction and operation as the aircraft 20 but may be suited for higher speeds and greater maneuverability operations, such as might be required for military use.

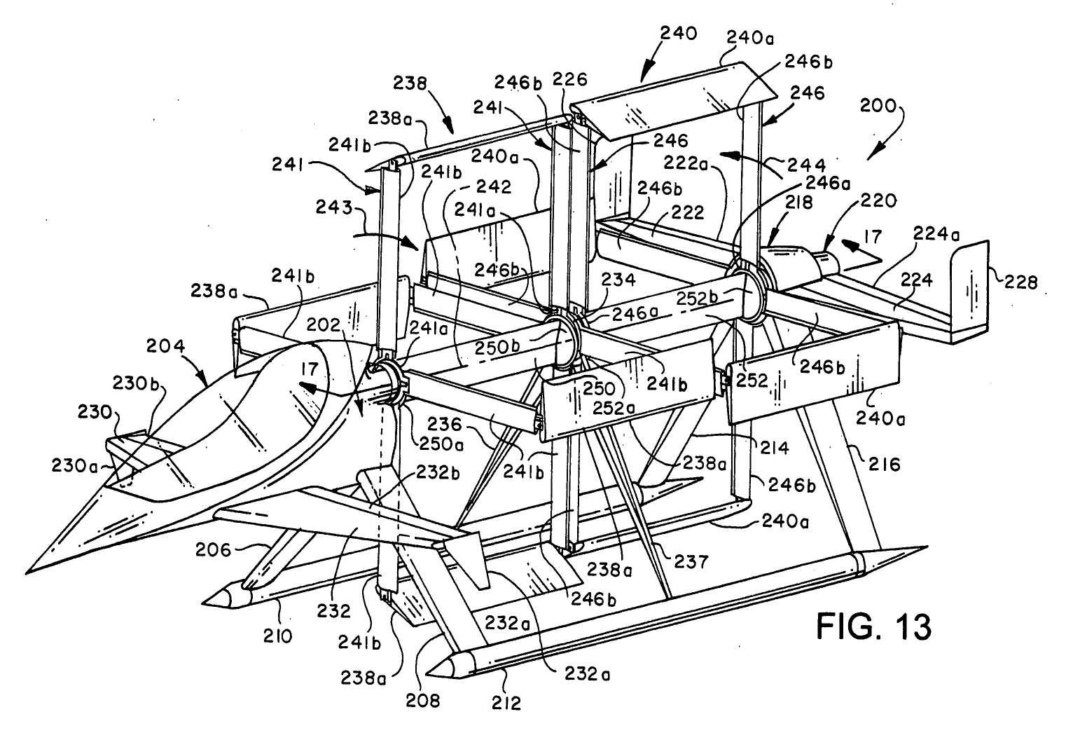

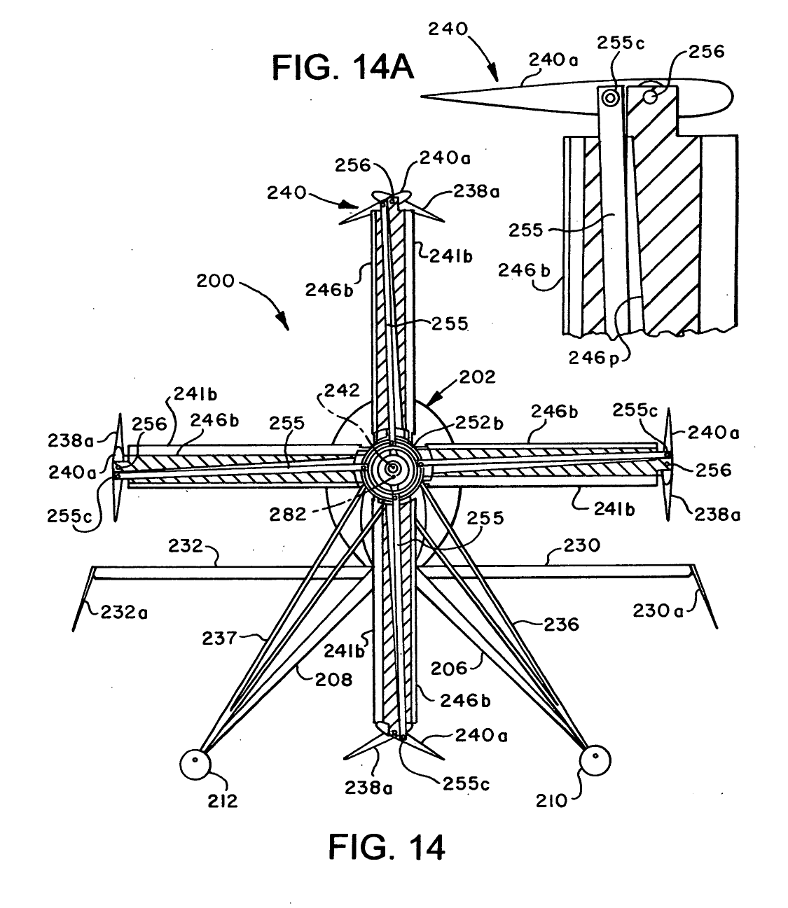

Referring now to FIGS. 13 and 14, another preferred embodiment of a rotary wing aircraft in accordance with the invention is illustrated and generally designated by the numeral 200. The aircraft 200 includes a fuselage 202 including a cabin and cockpit section 204, opposed downwardly projecting angular oriented forward struts 206 and 208, longitudinal extending support skids 210 and 212 and aft angular oriented struts 214 and 216, as shown in FIG. 13, in particular. Struts 206 and 208 are suitably connected to the cabin and cockpit section 204 and to the longitudinal skids 210 and 212. Angular oriented struts 214 and 216 are connected to the skids 210 and 212 and at their opposite ends to a housing or nacelle 218 for a combined propulsion and rotor drive engine 220 which may be similar to engine 40. Housing or nacelle 218 supports opposed airfoils 222 and 224 which may be characterized as a horizontal stabilizer with movable elevator sections 222a and 224a, and the distal ends of the airfoil sections 222 and 224 support upstanding vertical stabilizer members 226 and 228 which may include movable rudder components, not shown.

Referring still further to FIG. 13, the forward or cabin and cockpit section 204 of fuselage 202 supports opposed laterally projecting airfoil sections 230 and 232. Downwardly projecting winglets 230a and 232a are mounted on the respective outboard ends of the airfoil sections 230 and 232. Movable control surfaces 230b and 232b may also be provided on the wings or airfoil sections 230 and 232 for controlling pitch and roll movement of the aircraft 200. The movement of the control surfaces 230b and 232b may be coordinated with movement of the control surfaces 222a and 224a to also control pitch and roll movement of the aircraft 200.

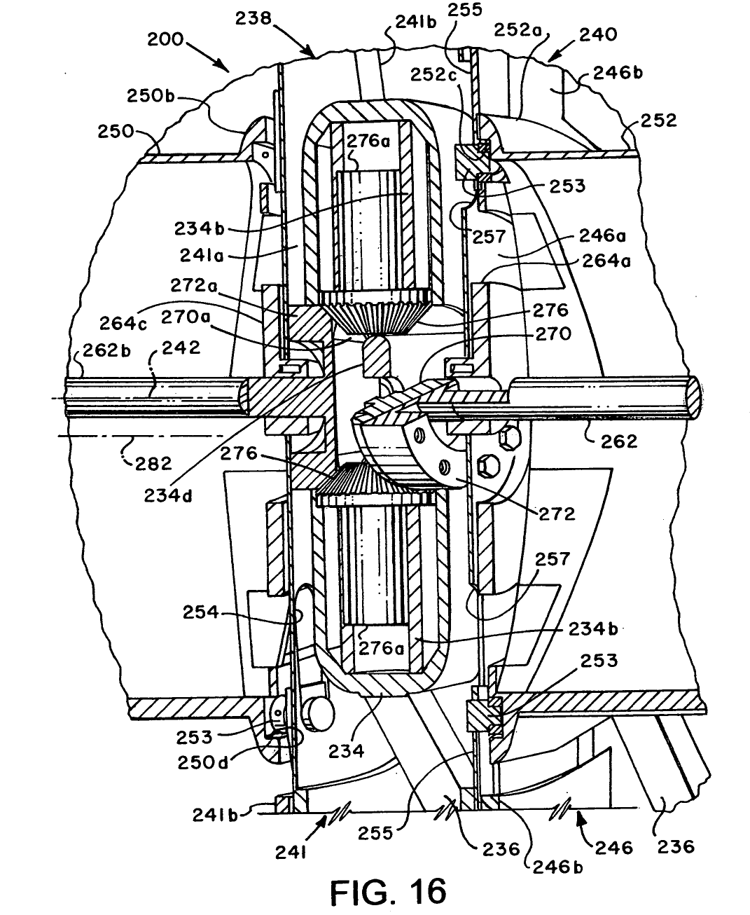

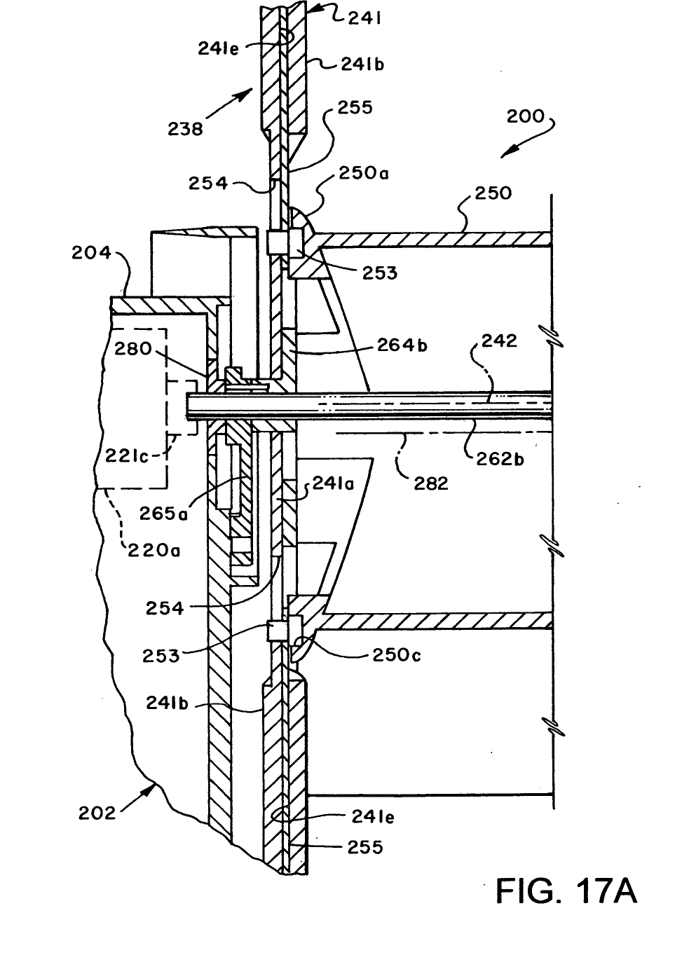

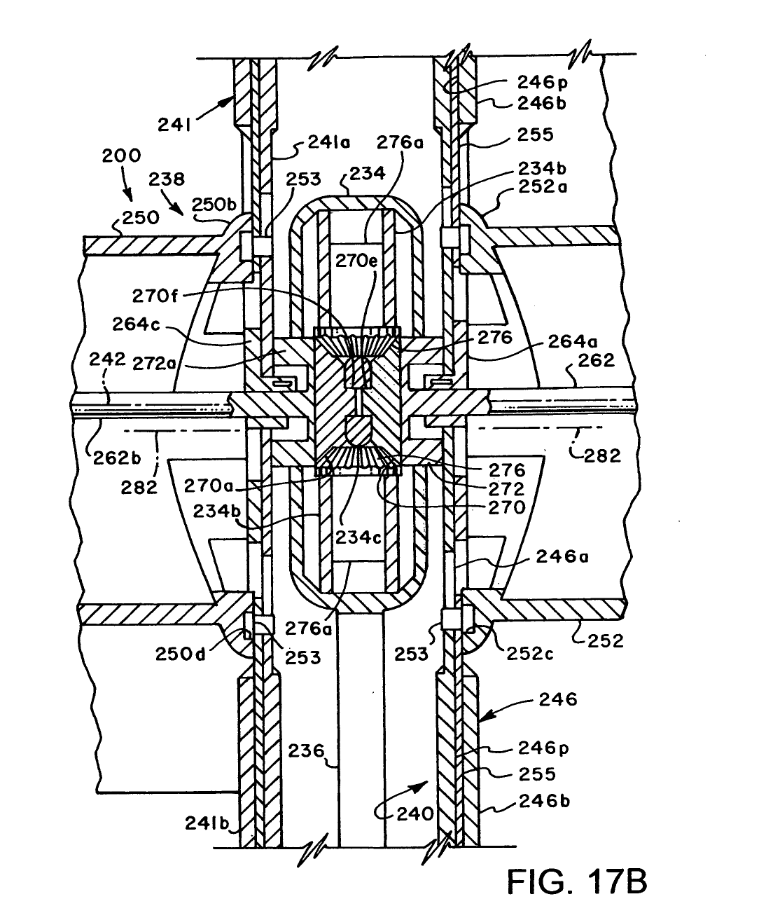

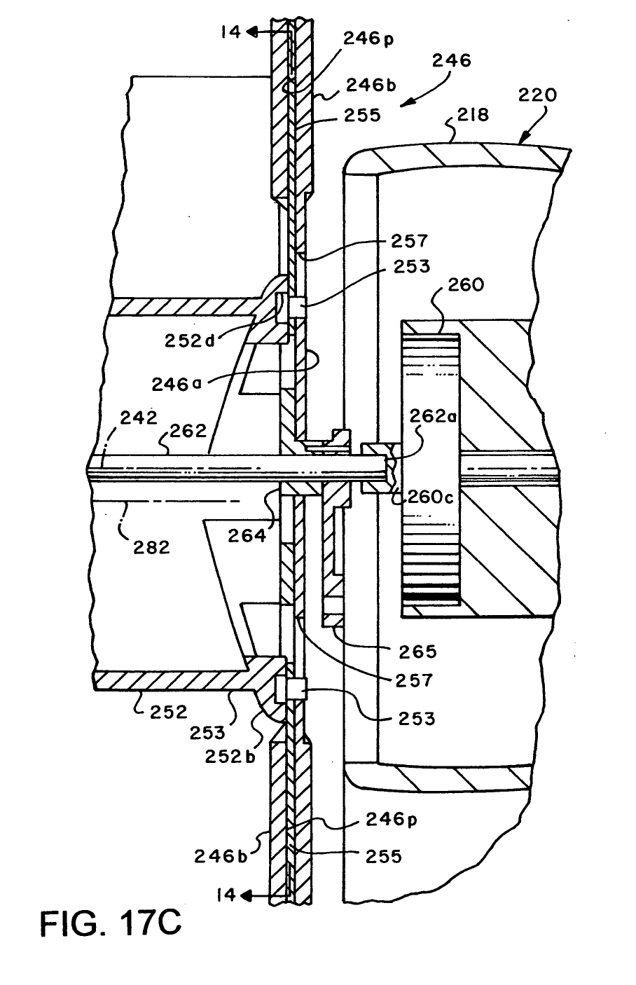

Referring briefly to FIGS. 16 and 17B, the aircraft 200 also includes a housing 234 for rotor drive mechanism to be described in further detail herein, which housing is supported on opposed downwardly projecting struts 236 and 237, FIG. 13, which are also connected at their ends opposite the housing 234 to the longitudinal skids 210 and 212, respectively. The forward cabin and cockpit section 204 of fuselage 202, the housing or nacelle 218 and the housing 234 cooperate to support longitudinally oriented spaced apart rotors 238 and 240, FIG. 13. Rotors 238 and 240 are arranged in a fore and aft configuration with the forward rotor 238 adapted to rotate about a longitudinal axis 242 in the direction indicated by arrow 243 while the aft rotor 240 is operable to rotate about axis 242 in the opposite direction, as indicated by the arrow 244. Rotors 238 and 240 are further characterized by circumferentially spaced apart longitudinally extending rotor blades 238a and 240a which have, preferably, symmetrical airfoil shaped cross sections, respectively. Rotor 238 includes spaced apart blade support members 241 which are characterized by hub portions 241a and radially projecting circumferentially spaced support arm members 241b, as illustrated in FIG. 13. In like manner, rotor 240 is also provided with spaced apart rotor blade support members 246 which are also characterized by respective hub portions 246a and radially extending circumferentially spaced blade support arm members 246b. Rotors 238 and 240 are cooperable with elongated somewhat airfoil shaped thrust or lift angle control members 250 and 252, respectively, in a manner described herein. Lift angle control members 250 and 252 comprise elongated somewhat airfoil shaped members having spaced apart, opposed, generally circular hub sections 250a and 250b, see FIGS. 17A and 17B with regard to member 250. Lift control member 252 is also provided with spaced apart opposed generally circular hub sections 252a and 252b, see FIGS. 17B and 17C.

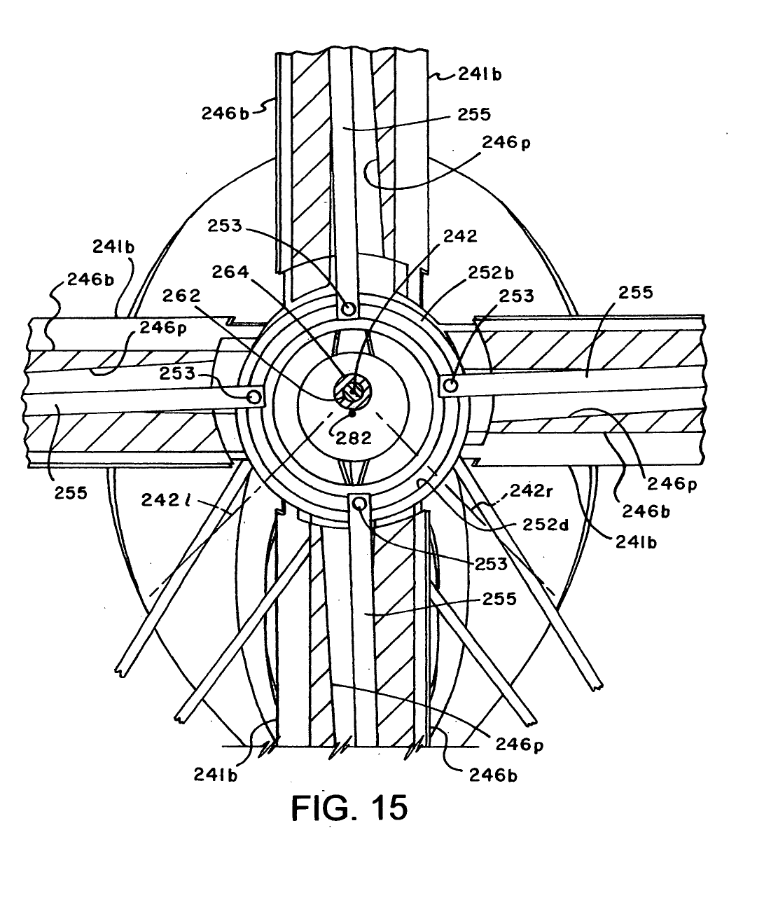

Referring to FIGS. 14, 14A, 15 and 17C, by way of example, there is illustrated the blade pitch and lift angle control mechanism for the aft end of rotor 240. As shown in FIG. 15, hub section 252b includes a generally circular channel or groove 252d formed therein and in which are disposed roller followers 253, FIG. 17C, each connected to an elongated blade angle of attack or pitch control actuator link 255 extending within an interior passage 246p of blade support members 246, respectively, and pivotally connected at their outboard ends, respectively, to rotor blades 240a, FIG. 14A, by way of pivot pin connections 255c. As shown in FIGS. 14 and 14A, rotor blades 240a are mounted for pivotal movement at their respective opposite ends on blade support arm members 246 at pivots or pivot pins 256, respectively.

The opposite end of rotor 240 is of essentially the same configuration wherein roller followers 253 are disposed spaced apart in a circular groove 252c, FIG. 17B, formed in hub 252a and concentric with groove or channel 252d. Roller followers 253 at the forward end of rotor 240 are secured to blade actuator links 255 also slidably disposed in passages 246p formed in the rotor blade support members 246b, as illustrated in FIG. 17B. Roller followers 253 are movable within slots 257 formed in hub portions 246a of rotor support members 246, see FIG. 17C, by way of example. The central axis 282 of the circumferential channels or grooves 252c and 252d is eccentric with respect to the axis 242, FIGS. 15 and 17C.

Referring again to FIG. 17C, propulsion engine 220 includes shaft power output drive mechanism 260, preferably comprising a speed reduction gear drive unit, having an output shaft 260c which is drivingly connected to a rotor drive shaft 262 and supports an end 262a of such shaft. Shaft 262 supports a lift angle change mechanism hub 264 but is rotatable relative to hub 264. Hub 264 comprises actuator means including a radially extending arm 265 which is adapted to be connected to a lift angle change actuator device, not shown. Hub 264 is suitably secured to member 252 whereby rotation of arm 265 about axis 242 will also rotate member 252 and change the angular location of axis 282 and, thus, the location of eccentricity of grooves or channels 252c and 252d with respect to axis 242. Shaft 262 extends through suitable bearing bores in members 264 and 265 and is rotatable relative to such members.

Referring to FIG. 17A, rotor 238 is constructed essentially identical to the rotor 240 and the rotor support arms 241b support the rotor blades 238a in the same manner as the blades 240a are supported on rotor 240. As shown in FIG. 17A, hub 250a of lift angle change or control member 250 is provided with a circular channel or groove 250c in which spaced apart roller followers 253 are disposed and attached to elongated actuator links 255 disposed for sliding movement within slots or passages 241e provided in blade support arm members 241b. Arm members 241b are integrally formed with support member hub 241a and which hub includes elongated slots 254 to provide clearance for roller followers 253. Member 250 is supported at its forward end by a bearing hub 264b and is connected thereto for limited rotation with hub 264b about axis 242. Hub 264b is connected to an actuator arm 265a which, in turn, is connected to actuator means, not shown, for effecting limited rotation of member 250 about axis 242.

Referring to FIGS. 16 and 17B, shaft 262 extends forwardly through control member 252 to its opposite end and within housing 234 and is drivably connected to a bevel gear 270 having a hub portion 272 secured to hub 246a of rotor blade support member 246 at the forward end of rotor 240. Bevel gear 270 is meshed with opposed idler bevel gears 276, each including a hub 276a mounted in suitable bearing means 234b, respectively, for rotation in housing 234 and meshed with a second bevel gear 270a which is secured to a hub 272a. Gear hub 272a is secured to hub part 241a of the aft blade support member 241 for the forward mounted rotor 238 for driving rotation of rotor 238. As shown in FIG. 17B, rotor 238 is also cooperable with lift angle control member 250 having a circular channel or groove 250d formed in hub part 250b and coaxial with groove 250c in hub part 250a, FIG. 17A. Circular grooves or channels 250c, 250d, 252c and 252d are coaxial with each other about axis 282 which is eccentric (spaced from and parallel) with respect to axis 242. Accordingly, the aft rotor support member 241 of rotor 238 is secured for rotation with hub 272a of bevel gear 270a and rotates in the direction indicated in FIG. 13 with respect to the direction of rotation of rotor 240, as also indicated in FIG. 13. For example, viewing FIG. 14, rotor 238 rotates in a counterclockwise direction while rotor 240 rotates in a clockwise direction.

Referring further to FIGS. 17A and 17B, bevel gear 270a is drivingly connected to elongated shaft 262b rotatable about axis 242 and which also supports the aft end of lift angle change control member 250 on a bearing hub 264c and shaft 262b is rotatable relative to the hub. As shown in FIG. 17A, the forward end of shaft 262b extends through and is rotatable relative to bearing hub 264b and is supported in suitable bearing means 280 mounted on forward fuselage member or cabin structure 204. Shaft 262b may be drivenly connected to an auxiliary or backup engine 220a disposed in fuselage 202 by way of suitable one way clutch means 221c, as shown in FIG. 17A. Gears 270 and 270a include respective stub shaft end parts 270e and 270f, FIG. 17B, supported for rotation in suitable bearing means 234c. Rotor support member hub parts 241a and 246a are supported on and rotate relative to respective members 264b, 264c, 264a and 264.

Referring further to FIG. 17A, actuator means for rotor 238 including a radially extending actuator arm 265a connected to hub 264b and to member 250 may be rotated independently of rotation of actuator means which includes the arm 265, FIG. 17C, to change the aforementioned thrust or lift angle for the rotor 238 with respect to the fuselage 202 and with respect to the rotor 240.

Accordingly, the rotors 238 and 240 are driven by engine 220 through drive mechanism 260, shaft 262, gears 270, 276 and 270a with gears 270 and 270a being drivably connected to the rotors 240 and 238, respectively, through hubs 272 and 272a. Thanks to the idler gears 276, the direction of rotation of rotor 238 is opposite that of rotor 240 thereby canceling adverse forces acting on the aircraft 200 and providing for enhanced maneuverability. Thanks also to the location of the generally circular grooves 250c, 250d in the member 250 and grooves 252c and 252d in the member 252 which have a central axis 282, FIG. 15, eccentric with respect to the axis 242, the pitch or angle of attack of the rotor blades 238a and 240a varies with each revolution of the rotors 238 and 240 to create lift in a desired direction. This operation is carried out as a consequence of the roller followers 253 on each end of the rotors 238 and 240 effecting movement of the blade pitch change control links 255 to change the pitch or angle of attack of the blades 238a and 240a as the rotors rotate.

For example, viewing FIG. 14, it will be noted that, when the eccentricity or position of the axes 242 and 282 relative to each other is such that the axis 242 is directly above the axis 282, see FIG. 15 also, the lateral lift angle is essentially zero whereby both rotors 238 and 240 are providing essentially maximum thrust or lift along a vertical line passing through the axes 242 and 282. Thus, as shown in FIG. 14, rotor blades 238a and 240a are disposed at a substantial angle of attack as they pass each other at a point directly vertically above the axis of rotation of shaft 242 and the angles of attack or pitch of both sets of blades 238a and 240a decrease as the blades pass through a horizontal line or plane, viewing FIG. 14. However, as the rotor blades 238a and 240a approach a position vertically below the axis 242, a so-called negative pitch or angle of attack of maximum incidence occurs for blades 238a and 240a which, again, tends to produce maximum lift. In the operating condition shown in FIG. 14, the change in pitch or angle of attack of the blades 238a and 240a, as the rotors 238 and 240 rotate, is such as to substantially cancel any forces tending to move the aircraft laterally while producing net effective upward thrust or lift forces.

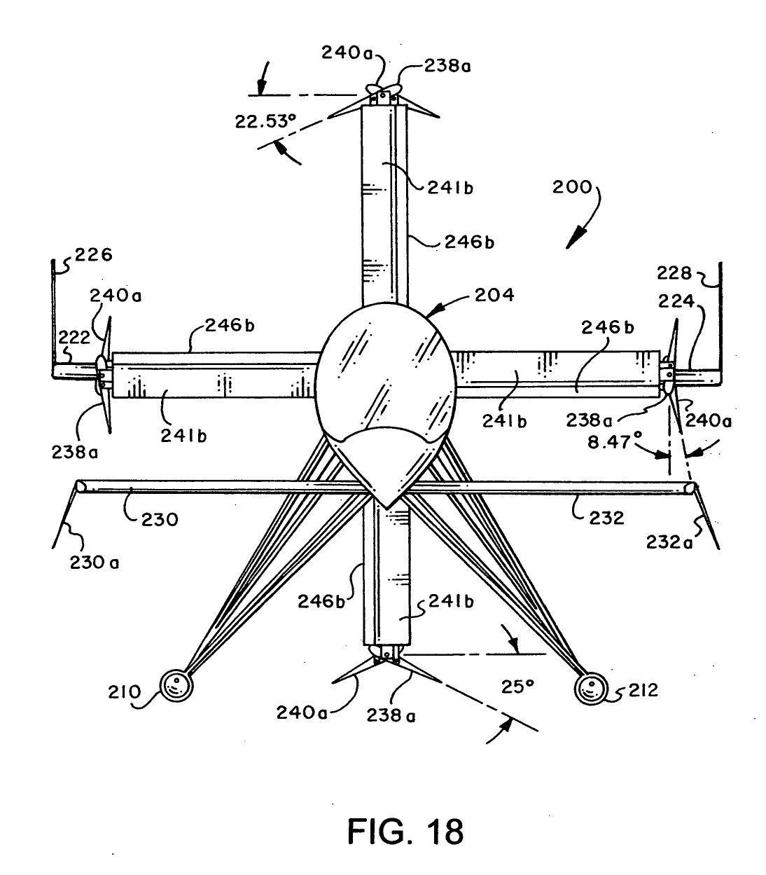

However, for example, if the members 250 and 252 are rotated in the same direction about axis 242, the direction of maximum or net resultant lift or thrust will move to an acute angle with respect to the vertical. If both members 250 and 252 are rotated, for example, twenty degrees with respect to the vertical, the blades 238a and 240a will be in the positions shown in FIG. 18 as they pass through the vertical and horizontal, respectively, creating a net lateral thrust force component tending to move the aircraft 200 upward and to the left, viewing FIG. 18.

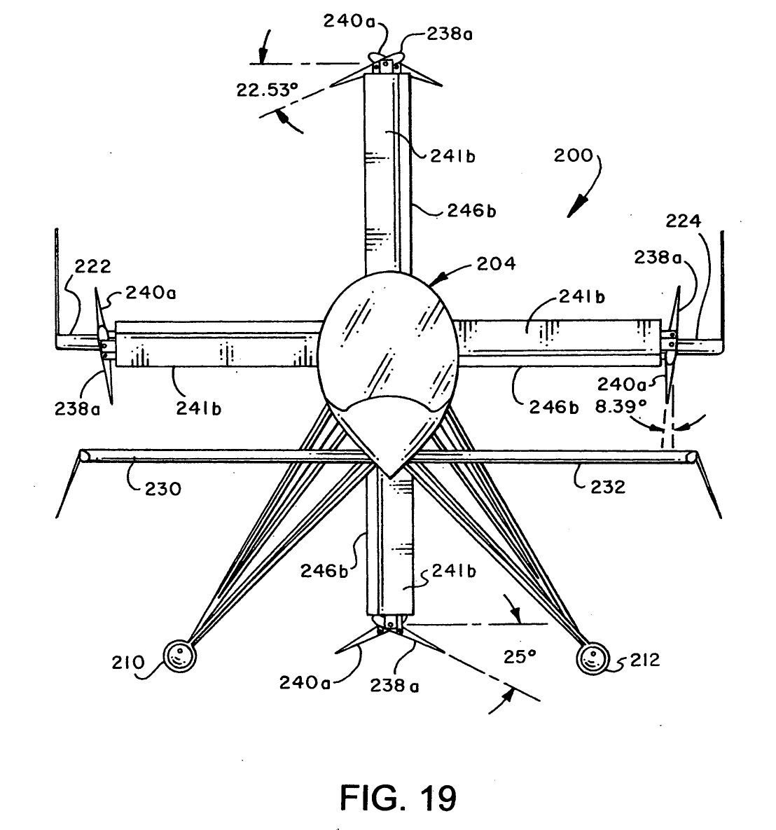

Conversely, if, as shown in FIG. 19, the oppositely rotating rotors 238 and 240 are subject to movement or rotation of their respective lift angle change control members 250 and 252 in opposite directions, rotor blades 238a will impose a net resultant lateral force on the aircraft 200 in one direction while the rotor blades 240a will generate a net resultant force tending to move the aircraft in the opposite direction about its yaw axis. In this way, the rotors 238 and 240 may be used to control the aircraft 200 to yaw or pivot about a vertical yaw axis, as desired. Thus, thanks to the so-called lift angle control mechanism provided by the members 250 and 252, suitable remotely controlled actuators connected to the arms 265 and 265a and the configuration of the rotor blade pitch control linkages, the aircraft 200 can be controlled to move vertically, at an angle to the vertical or laterally in either direction, and also to pivot about its own vertical or yaw axis in either direction. Rotation of the control members 250 and 252 about axis 242 is limited and, preferably does not exceed about forty-five degrees in either direction, as indicated by center lines 242l and 242r in FIG. 15. Forward motion is, of course, provided by propulsion from engine 220.

The aircraft 200 may be constructed using conventional engineering materials and techniques used for aircraft construction including the techniques and materials used for constructing the aircraft 20 and 100. The aircraft 200 enjoys the same benefits of construction and operation as the aircraft 20 and 100, but is also operable to provide substantial maneuverability.

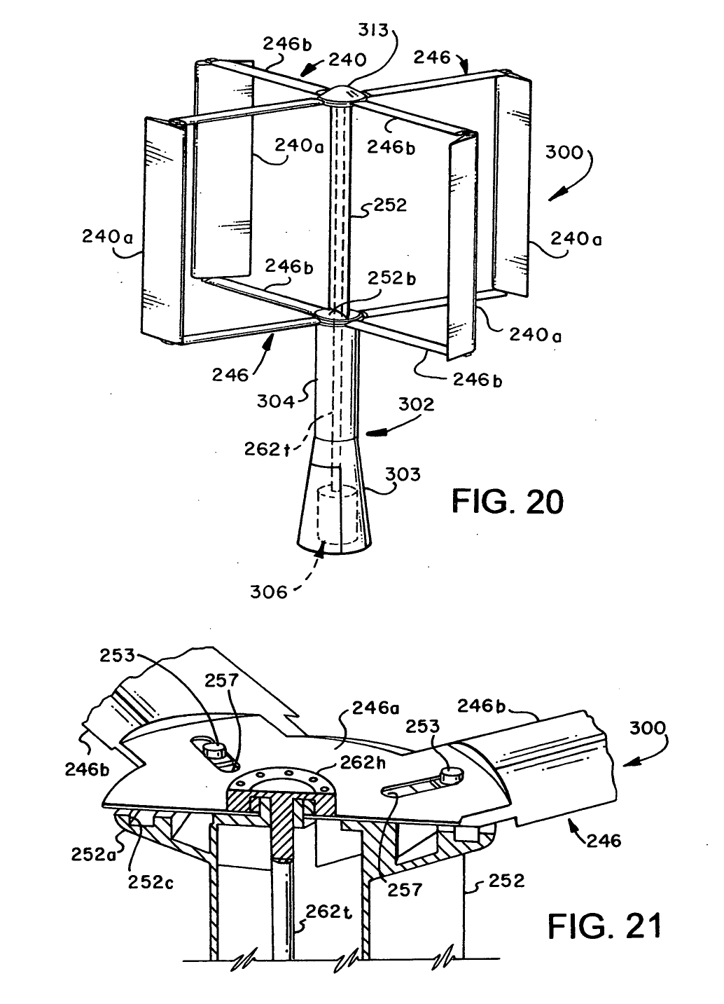

Referring now to FIG. 20, there is illustrated a wind driven power turbine which utilizes certain features of the rotary wing aircraft of the present invention. The wind driven power turbine of the invention is generally designated by the numeral 300 and may advantageously use one or more of the rotors 238 and 240. The rotor 240 is shown by way of example. Power turbine 300 is characterized by a support or base 302 comprising a generally cylindrical vertically extending mast part 304 extending above a frustoconical mast base 303. A suitable electrical generator or power takeoff device 306 is disposed within the mast base 303 and is drivenly connected to the rotor 240 by an elongated rotatable shaft 262t.

The rotor 240 shown in FIGS. 20 through 22 includes the same components as provided in the rotor 240 utilized in the aircraft embodiment 200. However, as shown in FIG. 21, the connection between the uppermost rotor blade support member 246 and the shaft 262t is modified somewhat, as indicated. Blade support hub 246a is drivingly connected to shaft 262t by a hub 262h which may support a spinner or cover 313, FIG. 20.

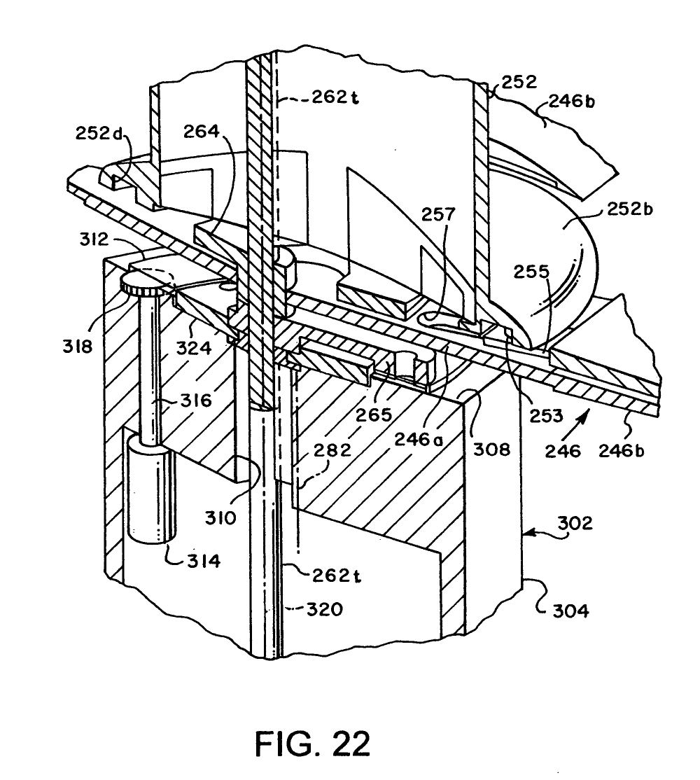

Referring now to FIG. 22, the mast section 304 includes an upper transverse wall 308 having a central vertically extending passage 310 form therein for clearance for the vertically extending shaft 262t. Wall 308 also suitably supports a generally cylindrical internal ring gear 312 for rotation with respect to the mast 302 and which is drivenly connected to a motor 314 by way of a rotary shaft 316 and pinion 318 connected thereto. Pinion 318 is meshed with internal ring gear 312 for rotating the ring gear to a selected position with respect to the mast 302 and about a central axis 320 which may also be the central axis of the shaft 262t. Ring gear 312 is also connected to actuator arm 265 of the lift or thrust angle control mechanism of the rotor 240. Arm 265 is connected to hub 264 which, in turn, is connected to the angle control member 252 for rotation therewith, as illustrated in FIG. 22. Accordingly, the eccentricity of the circular groove 252d, which has its central axis 282 spaced from the axis 320, may be oriented in any direction about the axis 320 by rotation of the ring gear 312 and the control arm 265 which is drivingly connected to the member 252.

Remote control of the motor 314 may be carried out manually or automatically as wind direction changes so that the pitch angle or angle of attack of the rotor blades 240a, FIG. 20, may be oriented for most efficient operation of the power turbine 300. Transverse wall 308 also supports a central bearing 324 which is adapted to support the rotor pitch change control mechanism including the actuator arm 265, the hub 264 and the member 252. Rotor 240 including the blade support members 246 and the rotor blades 240a are supported on bearing means which supports the shaft 262t, which bearing means may comprise a thrust bearing, not shown, provided in generator or power takeoff device 306. Such bearing means is only required to support the weight of the rotor 240, however, including members 246 and blades 240a.

As mentioned previously, a wind driven power turbine in accordance with the invention may also utilize additional rotors, such as the rotor 238 which could be connected to the shaft 262t through a direction of rotation reversing gear mechanism such as provided for the aircraft 200. Those skilled in the art will, however, realize that the power turbine 300 offers certain advantages in wind driven power turbines heretofore unappreciated by the prior art. The power turbine 300 may be constructed using known practices and materials used for power turbines or rotary wing aircraft, for example.

Although preferred embodiments of the invention have been described in detail herein, those skilled in the art will recognize that various substitutions and modifications may be made without departing from the scope and spirit of the appended claims.

What is claimed is:

1. A rotary wing aircraft comprising:
a fuselage;
spaced apart counter-rotating rotors mounted on said fuselage for rotation in opposite directions, said rotors including plural, circumferentially spaced apart, longitudinally extending rotor blades supported for change in pitch or angle of attack during rotation thereof to provide lifting effect for said aircraft; and
engine means driveably connected to said rotors.

2. The aircraft set forth in claim 1 wherein:
said rotors are coaxial.

3. The aircraft set forth in claim 2 wherein:
said rotors are arranged in tandem and with respect to an axis of rotation at least substantially parallel to a longitudinal axis of said aircraft.

4. The aircraft set forth in claim 1 wherein:
each of said rotors include spaced apart rotor support rings supported for rotation with respect to said fuselage, said rotor support rings being interconnected by spaced apart longitudinally extending rotor blades supported by said support rings for limited pivotal movement with respect thereto.

5. The aircraft set forth in claim 4 wherein:
said rotor support rings are supported by stationary bearing rings disposed on said fuselage.

6. The aircraft set forth in claim 5 wherein:
said bearing rings are supported at spaced apart stationary support ring members, each of said support ring members including a generally circular guide track having an axis eccentric with respect to the axis of rotation of said rotors.

7. The aircraft set forth in claim 6 wherein:
said rotor blades are connected to brackets at least at one end thereof, respectively, which brackets are connected to respective track followers, said track followers being disposed in one of said guide tracks associated with said stationary support ring members, respectively, for effectively changing one of the pitch and angle of attack of said rotor blades during rotation thereof to provide a lifting effect on said aircraft.

8. The aircraft set forth in claim 5 wherein:
power transmission means drivingly connected to at least one of said rotor support rings for transmitting power to said rotors, said power transmission means including a gear meshed with a gear mounted on at least one of said rotor support rings.

9. The aircraft set forth in claim 8 including:
idler gear means engaged with gear means formed on adjacent rotor support rings for respective ones of said rotors for at least one of transmitting power from one rotor to another and for driving one rotor in a direction opposite to that of the other rotor.

10. The aircraft set forth in claim 5 wherein:
said rotor blades have an airfoil cross-section shape.

11. The aircraft set forth in claim 1 including:
auxiliary engine means operable to be drivingly connected to at least one of said rotors.

12. The aircraft set forth in claim 11 wherein:
said auxiliary engine means is drivingly connected to said one rotor via power transmission means.

13. The aircraft set forth in claim 12 wherein:
said power transmission means includes an overrunning clutch.

14. The aircraft set forth in claim 1 wherein:
said rotor blades are mounted for pivotal movement on respective rotor support rings, respectively, and said rotor blades are guided for limited pivotal movement with respect to said rotor support rings for effecting a change of pitch or angle of attack of said rotor blades with respect to their directions of rotation, respectively.

15. The aircraft set forth in claim 1 wherein:
said fuselage includes a cabin mounted forwardly on said elongated body part and said engine means is mounted aft on said elongated body part.

16. The aircraft set forth in claim 15 including:
low aspect ratio wings secured to said fuselage.

17. The aircraft set forth in claim 14 including:
horizontal and vertical stabilizer means mounted on said fuselage and including moveable control surfaces for controlling one of pitch and yaw, respectively, of said aircraft.

18. The aircraft set forth in claim 1 wherein:
said fuselage includes an elongated body part including a rotor downwash exit duct formed therein; and
movable guide vanes are mounted in said duct for directing rotor wash in longitudinal directions for controlling at least one of pitch and longitudinal movement of said aircraft.

19. The aircraft set forth in claim 18 including:
longitudinally oriented guide vanes disposed in said duct for directing rotor wash laterally for controlling at least one of lateral movement, roll and yaw of said aircraft.

20. The aircraft set forth in claim 1 wherein:
said rotors are mounted side by side for rotation about longitudinal axes generally parallel to a longitudinal central axis of said aircraft.

21. The aircraft set forth in claim 1 wherein:
said rotors include spaced apart sets of circumferentially spaced radially extending blade support arms, each of said set of arms including a hub portion, said hub portions being connected to drive means drivenly connected to said engine means.

22. The aircraft set forth in claim 21 wherein:
said fuselage includes a transmission housing, a drive shaft drivenly connected to said engine means, first gear means drivenly connected to said drive shaft and drivingly connected to second gear means, said first and second gear means being drivingly connected to respective ones of said rotors for driving said rotors for rotation in opposite directions.

23. The aircraft set forth in claim 22 including:
rotor lift angle control members operably connected to each of said rotors.

24. The aircraft set forth in claim 23 wherein:
said lift angle control members include respective opposed grooves receiving followers operably connected to said rotor blades, respectively, for varying the angle of attack of said rotor blades as said rotors rotate.

25. The aircraft set forth in claim 24 wherein:
each of said rotor blades is connected to a link connected to one of said followers, respectively, and responsive to rotation of said rotors to change the angle of attack of said rotor blades.

26. The aircraft set forth in claim 24 including:
actuator means connected to each of said lift angle control members for rotating said lift angle control members to move an axis of said grooves with respect to an axis of rotation of said rotors to change a net resultant direction of lift imposed on said aircraft during rotation of said rotor blades.

27. The aircraft set forth in claim 26 wherein:
said actuator means are independently movable to change the direction of lift forces generated by said rotors, respectively, to provide for selectively moving said aircraft laterally and for rotating said aircraft about a substantially vertical yaw axis.

28. A wind driven power turbine comprising:
a rotor support mast;
a rotor supported for rotation on said mast, said rotor including plural, circumferentially spaced apart longitudinally extending rotor blades supported for change in pitch or angle of attack during rotation thereof, said rotor blades being supported by spaced apart sets of circumferentially spaced radially extending blade support arms, each set of arms including a hub portion, at least one of said hub portions being drivingly connected to a driveshaft.

29. The power turbine set forth in claim 28 wherein:
said rotor includes rotor blade pitch angle control member operably connected to said rotor blades to change the pitch of said rotor blades with respect to the direction of wind impinging on said rotor.

30. The power turbine set forth in claim 29 wherein:
said pitch angle control member includes respective opposed grooves receiving followers operably connected to said rotor blades, respectively for varying the angle of attack of said rotor blades as said rotor rotates.

31. The power turbine set forth in claim 30 wherein:
each of said rotor blades is connected to a link connected to one of said followers, respectively, and responsive to rotation of said rotor to change the pitch angle of said rotor blades, respectively.

32. The power turbine set forth in claim 30 including:
actuator means connected to said angle control member for rotating said angle control member to move an axis of said groove with respect to an access of rotation of said rotor.

33. The power turbine set forth in claim 32, wherein:
said actuator means includes a motor drivingly connected to a pinion, said pinion being meshed with a ring gear mounted on said mast for selectively changing the pitch angles of said blades with respect to the direction of wind impinging on said rotor.
